(19) United States
(12) Patent Application Publication
(10) Pub. No.: US 2008/0040380 A1
(43) Pub. Date: Feb. 14, 2008

(54) Providing revisory scenes in a media environment

(76) Inventor: Ken Miyaki, San Diego, CA (US)

Correspondence Address: CARR & FERRELL LLP, 2200 GENG ROAD, PALO ALTO, CA, 94303, US

(21) Appl. No.: 11/789,508

(22) Filed: Apr. 24, 2007

Related U.S. Application Data
(63) Continuation-in-part of application No. 11/502,265, filed on Aug. 9, 2006.

(51) Int. Cl. G06F 17/00

(52) U.S. Cl. 707/102; 707/E17.005

(57) ABSTRACT

A system and method for providing revisory scenes in a media environment is provided. A digital item of media may be revised by dividing an item of digital media into one or more segments. A tag may be assigned to the one or more segments. The item of digital media may be then be revised according to the tag.

### CROSS-REFERENCE TO RELATED APPLICATION

The present application is a continuation-in-part and claims the priority benefit of U.S. patent application Ser. No. 11/502,265 filed Aug. 9, 2006 and entitled “Dynamic Rating of Content.” The disclosure of this application is incorporated herein by reference.

### BACKGROUND OF THE INVENTION

1. Field of the Invention

The present invention relates generally to media editing, and more particularly to systems and methods for providing revisory scenes in a media environment.

2. Background of the Invention

Conventionally, various types of media are available to people via numerous resources. People in the present day information society may readily access the media via purchase, online viewing, or downloading. As such, various controls or ratings indicia have been established and are frequently imposed for controlling access to certain media. For example, a movie or video game may be rated to indicate that the movie or the video game may not be appropriate for children under a specified age. Accordingly, a purchaser or vendor can choose whether or not to allow a person to view the movie or interact with the video game according to the rating.

Disadvantageously, persons subjected to the rating such as the children under the specified age may be prevented from experiencing portions of the movie, video game or other media that may otherwise deemed appropriate for that person. In many instances, a single scene (e.g., an intense love scene) or even a few lines uttered by a character (e.g., profane language) may cause a particular movie or video game to be deemed inappropriate for a particular viewer. In some instances, the particular media (e.g., an art film or historical drama) may otherwise have strong educational or artistic merit. Because purchasers of a movie or a video game may frequently want their children to be able to view the movie or play the video game without having to manually skip material deemed inappropriate or to vigilantly monitor the same during viewing or game play, some companies have edited movies or video games to remove the material deemed inappropriate.

Unfortunately, the removal of the material deemed inappropriate is time consuming. Furthermore, the removal of the material may diminish consistency and coherency of a work being edited. Additionally, a particular series of edits may overcome the objections of some persons but not those of others because of different moral values and the like. Moreover, it is not clear that editing and subsequently marketing the work by third-parties is entirely legal with respect to, for example, copyright laws.

### SUMMARY OF THE INVENTION

A system and method for providing revisory scenes in a media environment is provided. According to an exemplary method, a digital item of media may be revised by dividing an item of digital media into one or more segments. A tag may be assigned to the one or more segments. The item of digital media may then be revised according to the tag.

According to another exemplary method, a revisory scene to associate with the tag may be generated. One or more users may be allowed to select the revisory scene from a menu and the item of digital media may then be revised with the revisory scene selected.

### BRIEF DESCRIPTION OF THE DRAWINGS

FIG. 1 illustrates a schematic diagram of an exemplary environment for providing revisory scenes in a media environment;

FIG. 2 illustrates a schematic diagram of an exemplary media revision engine;

FIG. 3 illustrates a flow diagram of an exemplary process for revising an item of digital media; and

FIG. 4 illustrates a schematic diagram of an exemplary menu.

### DETAILED DESCRIPTION

Revisory scenes may be provided for revising an item of digital media. The digital media may be divided into various segments. The revisory scenes may then be utilized to replace the various segments, add to the various segments, or to otherwise modify the item of digital media by manipulating the various segments.

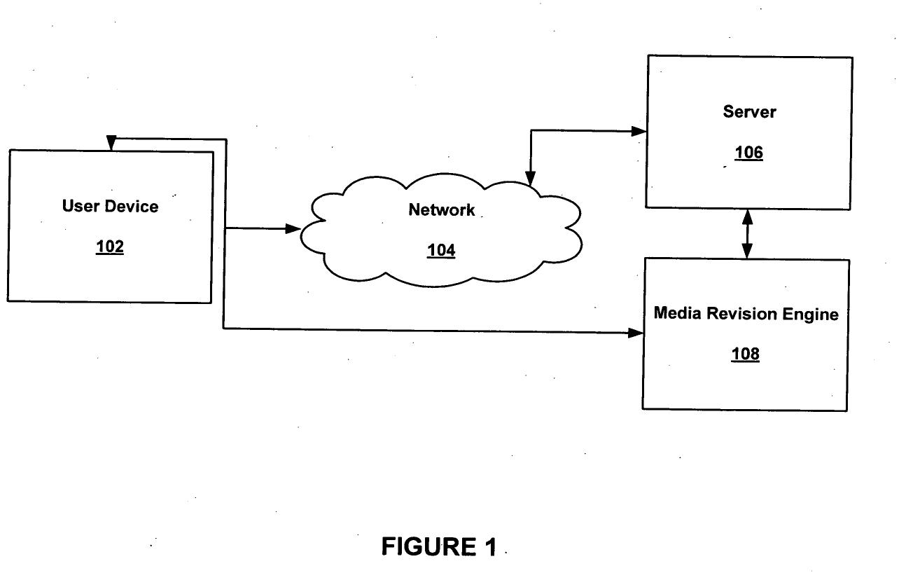

FIG. 1 illustrates a schematic diagram of an exemplary environment for providing revisory scenes in a media environment. The elements identified in FIG. 1 are exemplary and may include various alternatives, equivalents, or derivations thereof. A user device 102 may be coupled to a server 106 via a network 104. Any type of user device 102 may be provided, such as a digital television, gaming device such as a PlayStation3 from Sony Computer Entertainment Inc., a personal digital assistant, a cellular telephone, a set-top box, a laptop or desktop computer, and so forth. Other alternative, equivalent, or derived devices for interacting with revisory scenes and digital media may be used in the practice of the presently disclosed invention.

A media revision engine 108 may be coupled to the server 106. The media revision engine 108 may receive one or more items of digital media and may revise the digital media according to various processes. The digital media may comprise any type of media, such as a movie or a video game. Any type of server 106 may be provided. In one exemplary embodiment, the server 106 may be associated with a provider of the digital media.

The media revision engine 108 may reside on the server 106 or be coupled to the server 106, as discussed herein. In one alternative embodiment, the user device 102 may be coupled directly to the media revision engine 108 or may be integrated with the same. In another embodiment of the present invention, the user device 102 may be coupled to the media revision engine 108 directly via the network 104.

The media revision engine 108 may receive the digital media from the server 106, from the user device 102, or from any other source. For example, the media revision engine 108 or the server 106 may retrieve the digital media over the Internet.

The media revision engine 108 may be configured to divide the digital media into one or more segments and ‘tag’ the segments. The ‘tags’ may then be utilized to determine where revisory scenes may be inserted. Revisory scenes may be used to replace existing segments, and/or where segments may be skipped.

The revisory scenes may comprise any type of digital segment of media including those generated in association with the item of digital media. For example, the revisory scene may nearly mimic a segment from the digital media that contributes to an adult rating. The revisory scene, however, may be granted a lower rating (e.g., PG versus R) than the scene it may be intended to replace. As another example, the revisory scene may comprise extra scenes from a movie not included in the movie but otherwise available for insertion where the extra scenes may have been originally intended to be included in the movie (e.g., deleted scenes and outtakes).

Revisory scenes may be made available as a part of a library accessible via a network or on a storage device (e.g., optical disc, flash memory, and so forth). Revisory scenes may be provided by the original content provider (e.g., a movie studio) or a third-party provider of such content. In the latter example, certain companies may professionally specialize in removing or digitally manipulating particular portions of a scene such that objectionable or other material may be removed without the appearance of the scene having been edited. Revisory scenes may include advertising, promotions, or previews and be provided by a particular sponsor or manufacturer or a particular good or service.

In some embodiments, revisory scenes may be generated by users and provided through a community publishing forum. Revisory scene content provided through a community forum may not be as professional in appearance as content generated by, for example, a movie studio. Notwithstanding, the content provided through a community form may be more varied, original, and desirable than content provided by the studio.

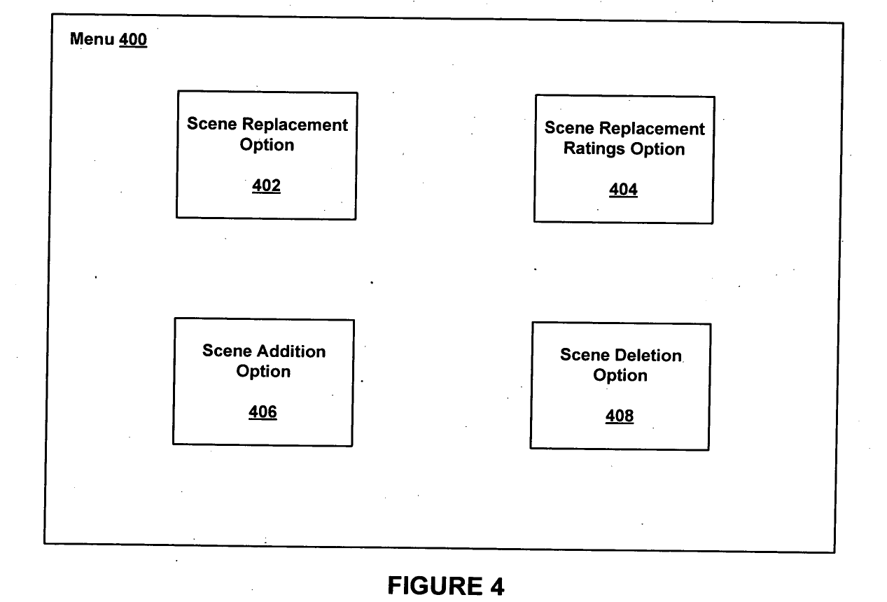

The revisory scenes may be displayed to a user such as a user accessing the digital media via the user device 102 in a menu like that described in the context of FIG. 4 below. For example, the user may select the one or more revisory scenes that the user wishes to incorporate into the item of digital media or to replace scenes in the item of digital media. As discussed herein, the user may also be presented with the option to skip existing scenes in the item of digital media.

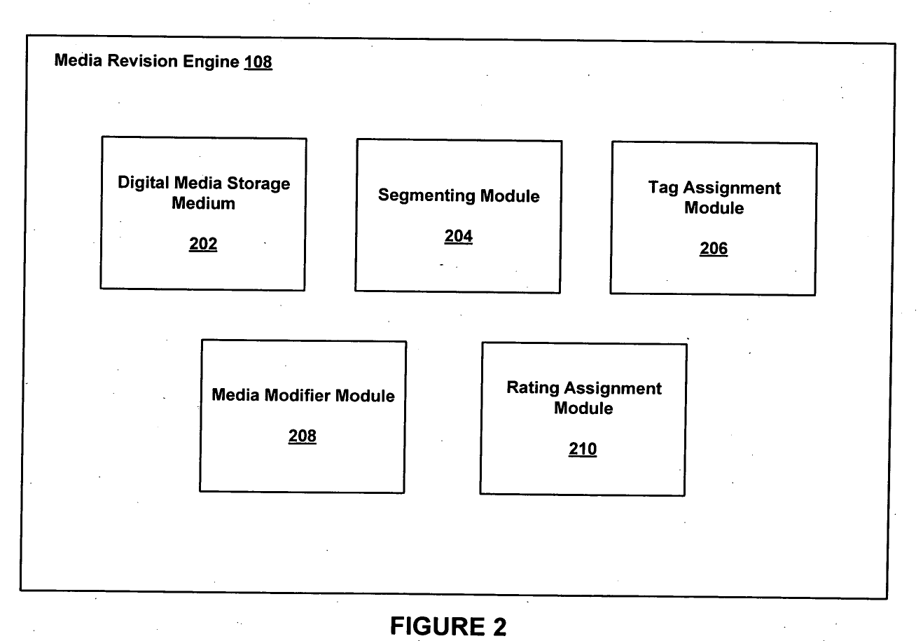

Referring now to FIG. 2, a schematic diagram of an exemplary media revision engine (like that referenced as element 108 in FIG. 1) is illustrated. The elements identified in FIG. 2 are exemplary and may include various alternatives, equivalents, or derivations thereof.

Digital media storage medium 202 may be provided for storing one or more items of digital media. As noted above, the digital media may be obtained from any available source. For example, community websites or digital data depositories may make available digital media for use in the practice of the present invention. These websites or digital data depositories may be accessed to obtain various digital media revisory scenes that may be pre-manufactured by a particular user, producer, or other third-party. These digital data depositories may be communal in nature wherein various users contribute various revisory scenes to the depository. Users may informed of new deposits of revisory scenes via, for example, an RSS feed.

Once the digital media is obtained, the digital media may, optionally, be stored in the digital media storage medium 202 at the media revision engine 108. Alternatively, the digital media may be stored at the user device 102, the server 106, or any other storage medium associated with or accessible by the user device 102, the server 106, or the media revision engine 108. As another alternative, the digital media may be stored at a remote location and accessed via the network 104.

A segmenting module 204 may access the digital media from the digital media storage medium 202 or from any other source providing such digital media. The segmenting module 204 may divide the item of digital media into one or more segments. Any process for dividing the item of digital media into the one or more segments may be employed. In one exemplary embodiment, the segmenting module 204 may divide the item of digital media into the one or more segments according to increments of time. For example, the item of digital media may be divided into one minute long segments. The item of digital media may, however, be divided into segments according to categories, chapters identified by the digital media provider, and so forth.

A tag assignment module 206 may assign one or more tags to each of the one or more segments. The tags may then be utilized to determine where revisory scenes are inserted or used to replace existing scenes or segments. The tags may also be utilized to skip existing scenes. Any type of tags may be assigned to the one or more segments.

A media modifier module 208 may utilize the tags to generate a modified item of digital media. For example, the media modifier module 208 may skip three segments identified by the segmenting module 204 according to various tags. The media modifier module 208 may obtain revisory scenes from any source. In one exemplary embodiment, the media modifier module 208 may generate revisory scenes to associate with the item of digital media. For example, the media modifier module 208 may replace subject matter with an adult rating in a segment identified by the segmenting module 204 with subject matter with, for example, a younger audience rating or the media modifier module 208 may skip the subject matter with the adult rating.

The media modifier module 208 may access user selections from a menu. The media modifier module 208 may then modify the item of digital media based on the user selections. For example, if the user selected two revisory scenes as replacement scenes, one revisory scene as an additional scene, and selected three existing scenes to be skipped, the media modifier module 208 may then generate the modified item of digital media based on the selections from the user. Any type of modifications may be performed by the media modifier module 208. In one exemplary embodiment, the media modifier module 208 may generate different modified versions of the item of digital media from which the user may choose. For example, the different modified versions may include different ratings, lengths, special features, and so forth.

The rating assignment module 210 may be configured to assign ratings to the one or more segments and/or to the revisory scenes. For example, the rating assignment module 210 may assign a PG-13 rating to one or more of the revisory scenes. Any type of ratings may be assigned by the rating assignment module 210 including ‘stars’ that may be used to indicate popularity of favorability of a particular scene. Various other information (e.g., metadata) may be assigned to a particular scene utilizing rating assignment module 210. In one exemplary embodiment, the rating assignment module 210 may be used to rate each of the one or more segments identified by the segmenting module 204. Any type of rating system may be utilized by the rating assignment module 210. In some embodiments of the present invention, the rating assignment module 210 may be used to generate a brief description (e.g., a user summary or narrative) of each segment or predetermined chapter associated with the item of digital media.

Although various modules are described as comprising the media revision engine 108 in FIG. 2, fewer or more modules may comprise the media revision engine 108 and still fall within the scope of various embodiments. For example, the media revision engine 108 may include a scene generation module for creating or retrieving a revisory scene.

Further, the various modules references in FIG. 2 may be subject to various access or modification controls. For example, the media modifier module 208 may require the entry of a pass code in order to manipulate or edit content as could the ratings module 210 or any of the other modules referenced in FIG. 2. By requiring the entry of a pass code, certain persons may be prevented from editing content or undoing the edits/controls of others with respect to particular portions of content. Such functionality may be of particular interest, for example, to a parent whose child is left unattended. By implementing pass code control, the child may be prevented from ‘undoing’ parent imposed edits and revisions as they pertain to removing or replacing scenes of a particularly violent or sexual nature in a movie or television program that the parent has otherwise given the child permission to watch.

Pass code functionality may also be of interest if one person wishes to watch a particular piece of content with certain revisory scenes whereas another person wishes to watch the same piece of content with different revisory scenes. By using a pass code, individual users may identify themselves to the media revision engine. Through user identification, user-specific revisions are displayed during playback of the content title. User identification may be specific to particular tags, associated revisory scenes, and so forth or particular content ratings. In the latter example, a parent (as identified by a pass code) may be provided with revisory scenes that are approved for children through adults whereas a teenager of a particular age may only be provided by revisory scenes that are deemed less than an ‘R-’ or other restricted rating.

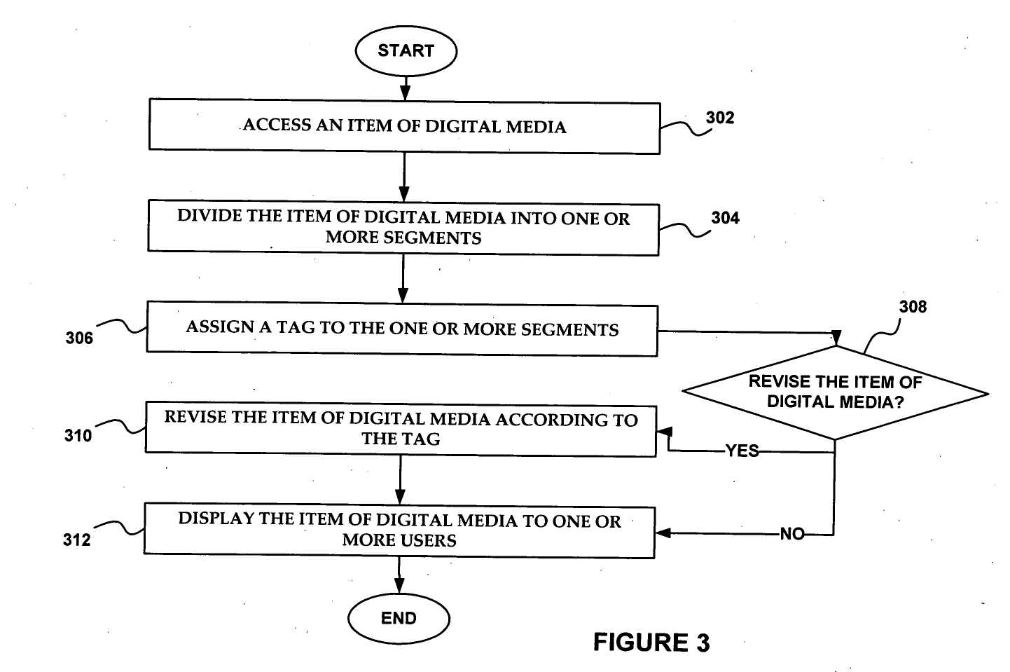

FIG. 3 illustrates a flow diagram of an exemplary process 300 for revising an item of digital media. The steps identified in FIG. 3 (and the order thereof) are exemplary and may include various alternatives, equivalents, or derivations thereof including but not limited to the order of execution of the same. The steps of the process of FIG. 3 (and its various alternatives) may be embodied in hardware or software including a machine-readable medium (e.g., optical disc, memory card, carrier waves, etc.) comprising instructions executable by a machine such as the processor of a computing device.

At step 302, an item of digital media may be accessed. The item of digital media may comprise a CD, a digital game, a digital movie, and so forth. The item of digital media may be accessed from any source.

At step 304, the item of digital media may be divided into one or more segments. For example, the segmenting module 204 associated with the media revision engine 108 may divide the item of digital media into the one or more segments. As discussed, any process may be employed for dividing the item of digital media into the one or more segments. Alternatively, the chapters or scenes identified in the item of digital media by the provider or creator of the item of digital media may be identified as the one or more segments, without further division.

At step 306, a tag may be assigned to the one or more segments. As discussed herein, the tag assignment module 206 may assign one or more tags to each of the one or more segments identified. Alternatively, the tag assignment module 206 may assign one or more tags to the chapters or scenes that comprise the item of digital media without further division by the segmenting module 204.

At step 308, the media revision engine 108 (or user thereof) may determine whether the item of digital media should be revised. For example, the media revision engine 108 may receive a request from a user at the user device 102, or from the server 106, to revise the item of digital media. If the media revision engine 108 determines that the item of digital media should be revised, the item of digital media may be revised according to the tag, at step 310. As discussed herein, the one or more segments can be skipped according to the tags or the revisory scenes may be inserted or used to replace existing scenes according to the tags. Any type of modification of the item of digital media may be implemented by the media modifier module 208.

At step 312, the item of digital media may be displayed to one or more users. If the item of digital media was modified at step 310, the item of digital media, as modified, may be displayed to the one or more users. If, at step 308, it is determined that the item of digital media should not be revised, the item of digital media may be displayed to the one or more users without modifications.

FIG. 4 shows a schematic diagram of an exemplary menu 400 that may be used in the practice of an embodiment of the present invention. As discussed herein, a menu, such as the menu 400, may be provided to the one or more users for selecting various options associated with the item of digital media. According to some embodiments, the media revision engine 108 may include a communications interface (not shown) for receiving selections from the user via the menu 400. The elements identified in FIG. 4 are exemplary and may include various alternatives, equivalents, or derivations thereof.

A scene replacement option 402 may be displayed to the user. The user may view one or more revisory scenes via the scene replacement option 402. For example, the user may select one or more revisory scenes to replace existing scenes in the item of digital media. The revisory scenes may be displayed next to one or more scenes the revisory scenes are intended to replace. For example, a particular revisory scene may be represented by a graphic or still shot of a scene, the graphic or still shot displayed next to a graphic or still shot of an existing scene the particular revisory scene should replace. A brief description of the particular revisory scene may be displayed and/or a brief description of how the particular revisory scene differs from the existing scene may be displayed in addition to or instead of the graphic or still shots of the particular revisory scene and/or the existing scene.

A scene replacement ratings option 404 may be selected by the user. The scene replacement ratings option 404 may display the ratings associated with each of the revisory scenes that may be intended to be used for scene replacements. For example, a scene replacement may have “PG-13” ratings or a “G” rating rather than the “R” rating assigned to the existing scene. Each revisory scene comprising the scene replacement may have a different rating. The revisory scenes comprising the scene replacements may be grouped according to ratings.

A scene addition option 406 may be provided to the user as part of the menu 400. The scene addition option 406 may display revisory scenes to be inserted into, or otherwise added to, the item of digital media. For example, the scene addition option 406 may display revisory scenes comprising movie outtakes, movie or game extras, and so forth.

A scene deletion option 408 may also be displayed to the user. The scene deletion option 408 may display all of the scenes, chapters, and/or segments to the user. The user may then select the scenes the user wishes to delete, or to otherwise not display as part of the item of digital media, from the scene deletion option 408. For example, the user may select four segments or one chapter that the user wishes to delete from the item of digital media. The media revision engine 108 may utilize the tags assigned by the tag assignment module 206 to skip the four segments or the one chapter selected by the user via the scene deletion option 408.

The scene deletion option 408 and/or the scene addition option 406 may provide ratings associated with each of the segments, scenes, chapters, and so forth. Accordingly, the user may select one or more of the segments, scenes, chapters, and so on for deletion and/or addition based on the ratings. As discussed herein, the tag assignment module 206 may assign tags to any increment identified in the item of digital media. Accordingly, any increment including the segments identified by the segmenting module or chapters previously associated with the item of digital media may be modified.

Although various options have been described as comprising the menu 400, fewer or more options may comprise the menu 400 and still fall within the scope of various embodiments. For example, a labeling or comment option may be provided that enables the user to label or comment on the one or more segments, chapters, scenes, and so forth. Accordingly, the user may identify the one or more segments, chapters, or scenes according to the user's own opinions or comments, for instance.

According to one exemplary embodiment, the one or more segments identified by the segmenting module 204 may be assigned an order. Each of the one or more ordered segments may be labeled and rated, such as by the rating assignment module 210. The user may then select one or more of the labeled and rated segments that the user wants to display. In one exemplary embodiment, the user may select the one or more segments originally comprising the item of digital media and/or one or more revisory scenes, such as replacement scenes or scene additions. Thus, the media revision engine 108 may generate the modified item of digital media according to the user selections.

For example, the modified item of digital media may include all of the original segments along with all of the extra scenes inserted. Alternatively, the media revision engine 108 may detect certain patterns with respect to user selection of revisory scenes (e.g., removal of all R-rated scenes and insertion of all PG-13 scenes or vice-versa). The media revision engine 108 may automatically revise the entirety of the digital media (or portions thereof, for example, chapter) such that the detected pattern is populated throughout the media or portion thereof. This population may occur upon a particular pattern having been detected or in response to a prompt presented through a user interface. Any type of modification of the item of digital media according to the tags is within the scope of various embodiments.

While various embodiments have been described above, it should be understood that they have been presented by way of example only, and not limitation. For example, any of the elements associated with the media revision engine 108 may employ any of the desired functionality set forth hereinabove. Thus, the breadth and scope of a preferred embodiment should not be limited by any of the above-described exemplary embodiments.

What is claimed is:

1. A method for revising an item of digital media comprising:
dividing an item of digital media into one or more segments;
assigning a tag to the one or more segments; and
revising the item of digital media according to the tag.

2. The method recited in claim 1, wherein the revising includes skipping at least one of the one or more segments according to the tag.

3. The method recited in claim 1, wherein the item of digital media comprises a game.

4. The method recited in claim 1, wherein the item of digital media comprises a movie.

5. The method recited in claim 1, further comprising inserting a revisory scene according to the tag.

6. The method recited in claim 5, wherein the revisory scene is inserted to replace at least one of the one or more segments.

7. The method recited in claim 5, wherein the revisory scene is inserted to add to at least one of the one or more segments.

8. The method recited in claim 5, wherein the revisory scene comprises a digital segment of media generated in association with the item of digital media.

9. The method recited in claim 5, further comprising assigning a rating to the revisory scene.

10. The method of claim 9, wherein assigning the rating to the revisory scene is pass code controlled.

11. The method recited in claim 5, further comprising providing the revisory scene to one or more users via a menu comprising one or more of the revisory scenes.

12. The method of claim 11, wherein access to the menu providing the revisory scenes is pass code controlled.

13. The method of claim 12, wherein the pass code determines a selection of scenes that are offered to the one or more users through the menu.

14. A system for revising an item of digital media comprising:
a segmenting module configured to divide an item of digital media into one or more segments;
a tag assignment module configured to assign a tag to the one or more segments; and
a media modifier module configured to revise the item of digital media according to the tag.

15. The system recited in claim 14, wherein the media modifier module is configured to skip at least one of the one or more segments according to the tag.

16. The system recited in claim 14, wherein the item of digital media comprises a game.

17. The system recited in claim 14, wherein the item of digital media comprises a movie.

18. The system recited in claim 14, wherein the media modifier module is further configured to insert a revisory scene according to the tag.

19. The system recited in claim 18, wherein the revisory scene is inserted to replace at least one of the one or more segments.

20. The system recited in claim 18, wherein the revisory scene is inserted to add to the at least one of the one or more segments.

21. The system recited in claim 18, wherein the revisory scene comprises a digital segment of media generated in association with the item of digital media.

22. The system recited in claim 18, further comprising a rating assignment module configured to assign a rating to the revisory scene.

23. The system of claim 22, wherein assigning the rating to the revisory scene is pass code controlled.

24. The system recited in claim 18, further comprising a menu comprising one or more of the revisory scenes, the menu configured to provide the revisory scenes to one or more users.

25. The system of claim 24, wherein access to the menu is pass code controlled.

26. The system of claim 25, wherein the pass code determines a selection of scenes that are offered to the one or more users through the menu.

27. A computer readable storage medium having embodied thereon a program, the program being executable by a processor to perform a method for revising an item of digital media, the method comprising:
dividing an item of digital media into one or more segments;
assigning a tag to the one or more segments; and
revising the item of digital media according to the tag.

28. The computer readable storage medium recited in claim 27, wherein the revising includes skipping at least one of the one or more segments according to the tag.

29. The computer readable storage medium recited in claim 27, wherein the item of digital media comprises a game.

30. The computer readable storage medium recited in claim 27, wherein the item of digital media comprises a movie.

31. The computer readable storage medium recited in claim 27, the method further comprising inserting a revisory scene according to the tag.

32. The computer readable storage medium recited in claim 31, wherein the revisory scene is inserted to replace at least one of the one or more segments.

33. The computer readable storage medium recited in claim 31, wherein the revisory scene is inserted to add to the at least one of the one or more segments.

34. The computer readable storage medium recited in claim 31, wherein the revisory scene comprises a digital segment of media generated in association with the item of digital media.

35. The computer readable storage medium recited in claim 31, the method further comprising assigning a rating to the revisory scene.

36. The computer readable storage medium of claim 35, wherein assigning a rating to the revisory scene is pass code controlled.

37. The computer readable storage medium recited in claim 31, the method further comprising providing the revisory scene to one or more users via a menu comprising one or more of the revisory scenes.

38. The computer readable storage medium of claim 37, wherein access to the menu is pass code controlled.

39. The computer readable storage medium of claim 38, wherein the pass code determines a selection of scenes that are offered to the one or more users through the menu.

40. A method for revising an item of digital media comprising:
dividing an item of digital media into one or more segments;
assigning a tag to the one or more segments;
generating a revisory scene to associate with the tag;
allowing one or more users to select the revisory scene from a menu; and
revising the item of digital media with the revisory scene selected.

41. The method of claim 40, wherein the menu is pass code controlled and the pass code determines a selection of offered scenes.

42. The method of claim 40, wherein the assignment of the tag to the one or more segments and the revision of the item of digital media is associated with an individual user.

43. The method of claim 42, further comprising displaying the revised item of digital media with the selected revisory scene based an identification of the individual user.

44. The method of claim 40, wherein subsequent segments of the item of digital media are automatically revised with available revisory scenes based upon one or more patterns identified in prior revisory scene selections by the user.

45. The method of claim 44, wherein the one or more patterns includes a rating for the prior revisory scene selections.

46. The method of claim 45, wherein the automatic revision includes replacement of segments with a first rating with revisory scenes of a second and lesser rating.

47. The method of claim 45, wherein the automatic revision includes replacement of segments with a first rating with revisory scenes of a second and higher rating,
